(19) United States
(12) Patent Application Publication
(10) Pub. No.: US 2013/0024448 A1
(43) Pub. Date: Jan. 24, 2013

(54) RANKING SEARCH RESULTS USING FEATURE SCORE DISTRIBUTIONS

(71) Applicants: RALF HERBRICH, Cambridge (GB); WILLIAM RAMSEY, Redmond, WA (US); ANTOINE ATALLAH, Bellevue, WA (US); THORE GRAEPEL, Cambridge (GB); PAUL VIOLA, Redmond, WA (US)

(72) Inventors: RALF HERBRICH, Cambridge (GB); WILLIAM RAMSEY, Redmond, WA (US); ANTOINE ATALLAH, Bellevue, WA (US); THORE GRAEPEL, Cambridge (GB); PAUL VIOLA, Redmond, WA (US)

(73) Assignee: MICROSOFT CORPORATION, Redmond, WA (US)

(21) Appl. No.: 13/187,721

(22) Filed: Jul. 21, 2011

(51) Int. Cl. G06F 17/30

(52) U.S. Cl. 707/728; 707/E17.014

(57) ABSTRACT

Document features or document ranking values can be associated with a distribution of values. Feature values, feature value coefficients, and/or document ranking values can be generated based on sampled values from the distribution of values. This can allow the relative ranking of a document to vary. As additional information is obtained regarding the document, leading to greater certainty about the appropriate ranking of the document, the width or variation generated by the distribution can be reduced to provide more stable ranking values

### BACKGROUND

Identifying appropriate documents that are responsive to a search query is an ongoing area of study. Many conventional search engines provide a user with an initial page of documents in response to a search query. The documents provided on the initial page are typically selected based on determining a document ranking relative to the search query. The document ranking can be based on a wide variety of features related to the content of the document, the organization of the document, the relationship of the document to other documents on a network, or various other features that might indicate that a document is responsive to a search query. A score can be assigned to the document features relative to the search query for each document, and the scores for a document can be added, multiplied, or otherwise combined to arrive at a ranking for a document.

### SUMMARY

In various embodiments, one or more document features for a document, optionally including the document ranking value for the document, can be associated with a distribution of values relative to a search query, as opposed to a single value. When a search query is submitted, sampled values can be generated from one or more distributions associated with document features or the document. The sampled values are then used to generate feature values or feature value coefficients for individual features and/or document ranking values for documents. Generating feature values or document ranking values based on sampled values from a distribution can allow the relative ranking of a document to vary, such as by allowing a document to have a different ranking relative to the same search query for two different instances of the search query. This can result in a change in the display location of a document link in a results page, allowing improved information to be gathered regarding user interactions with the document. As additional information is obtained regarding the document, leading to greater certainty about the appropriate ranking of the document, the width or variation generated by the distribution can be reduced to provide more stable ranking values.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 shows an example of a distribution.

FIG. 2 shows additional examples of distributions.

FIG. 3 schematically shows an example of a system suitable for performing embodiments of the invention.

FIG. 4 is a block diagram of an exemplary computing environment suitable for use in implementing embodiments of the present invention.

FIG. 5 schematically shows an example of a method according to an embodiment of the invention.

FIG. 6 schematically shows an example of a method according to an embodiment of the invention.

### DETAILED DESCRIPTION

### Overview

In various embodiments, systems and methods are provided for generating search results that incorporate user feedback regarding documents responsive to a search query. The systems and methods allow for variation in the order of display of results, in order to reduce or mitigate the impact on user feedback due to bias in where results are displayed. In some embodiments, the variation is introduced by treating one or more ranking features for a document as a distribution of values, as opposed to a single value. Alternatively, the variation can be introduced by assigning a distribution of values for the entire document rather than individual features. Using a distribution of values to represent features (or the document ranking) allows the ranking of a document to vary, leading to (for example) alternative placement of results for different instances of the same search query. As user feedback is received, the confidence in the ranking value that should be assigned to a feature and/or the document can improve, resulting in a narrowing of the width of the distribution.

In many situations, it is desirable to gather user feedback regarding the quality of documents provided as results in response to a search query. In this discussion, a document refers to any type of content item containing one or more content types that may be returned as responsive to a search query. Thus, a document includes, but is not limited to, text-based documents, pictures or images, videos or movies, audio clips, applications, or other content locations containing combinations of such content types.

User feedback can be used to improve the ranking of individual documents relative to one or more queries. This feedback can have added importance for search queries containing a limited number of keywords, such as a search query containing two keywords or less or a search query containing three keywords or less. A keyword is defined as one or more characters that a search engine can group together for use in identifying matching documents. Thus, a keyword can be a word, a partial word, or an arbitrary consecutive string of characters, numbers and symbols. In some situations, a keyword can also be two or more words/character strings separated by typical word separators, such as spaces. In still other situations, a keyword can be one or more characters that a search engine inserts into a search query that correspond to a non-text-based query submission. For example, if a picture or image is submitted as part of a query, a search engine may use one or more character strings in place of the image when performing a search based on the image. The one or more character strings can correspond to metadata associated with the image, or the character strings can be descriptive of the image.

In some alternative embodiments, a query may include features that are different from typical keywords. For example, a query for an image could include a histogram that describes the image. A query for a musical composition could include spectral features. A query descriptor is defined herein as any type of token included within a query that can be used for identifying a match. Thus, a keyword is a subset of a query descriptor. In this discussion, the term keyword will be used to describe various aspects of the invention. However, this is used only for clarity in describing the invention. Those of skill in the art will recognize that the discussion herein equally applies to search queries that more generally include query descriptors.

One option for obtaining user feedback is to hire a group of people to evaluate the matching value of a library of documents against one or more search queries. This provides a controlled method for generating user feedback on a set of documents and search queries. Unfortunately, these types of controlled experiments are expensive and time-consuming to implement. Additionally, these types of controlled experiments are typically performed on previously identified documents. As new documents appear on at least some searchable networks every day, it is difficult to apply such controlled experiments to new documents and/or new combinations of search query keywords.

A more dynamic way of obtaining user feedback is to track user interaction with results that are provided as responsive to a search query. Such information can be obtained, for example, by receiving the user's permission to install a toolbar or an application that monitors user interaction with a results page. When a user submits a search query, a results page is returned with document results that are considered to be responsive to the search query. The document results are typically links that correspond to a document location, along with some type of description of the document present at the location. In many situations, a search query will generate a large number of document results that are considered responsive, with only a portion of the results being displayed on a first page of results that is presented to a user. The display location on the results page for a result that is responsive to a search query is typically determined based on the ranking of the various displayed results.

A user's interest in the displayed results can be characterized in a variety of ways. Examples of user interactions that can be tracked include, but are not limited to, whether a user clicks on a displayed result, the amount of time an average user spends viewing a document after clicking on a result, or the amount of time a user interacts with a displayed result, such as by hovering a mouse pointer over a displayed result. Such user interactions can be aggregated over multiple users to determine the likelihood that a given result is actually responsive to a search query submitted by a user.

Unfortunately, there are a variety of potential factors that can bias a user's interaction with the results on a page of search results. A number of these factors relate to the display location for a result on a page. For example, many users will expect the first result listed on a page to correspond to the “best” matching result for a search query. A user may have an increased likelihood of clicking on or otherwise interacting with the first displayed result on a results page regardless of whether the result is actually responsive. This can be referred to as a “page location” bias by a user. Other types of page location bias may also exist with regard to how users interact with results displayed on a page. Due to this type of bias, it can be difficult to distinguish user activity (or inactivity) due to page location bias from user activity that demonstrates a genuine interest (or lack of interest) by a user with regard to a search result.

One option for reducing page location bias is to vary the display location of results in response to a search query. In order to provide a consistent user interface, it may be preferable to maintain the same overall format for a results page. Instead of modifying the page display format, the ranking of individual results can be modified. If a change in the ranking value for displayed results is sufficiently large, the relative order of ranking will change and therefore cause a change in the display location for one or more results. This can facilitate reducing or mitigating the impact of page location bias in evaluating user feedback. After sufficient feedback has been received, the amount of variation in ranking value can be reduced to reflect the greater certainty or confidence in the ranking of given document or document feature.

In various embodiments, variation in the ranking value for a document can be introduced at the document feature level, such as by representing one or more document feature values as a distribution of values. Optionally, a document can also have one or more additional features that are represented by single values. When a ranking value is calculated for a document, a distribution is sampled for each feature value represented by a distribution to generate a feature value for use in determining a particular instance of the document ranking value. Additionally or alternatively, a distribution of values can be used for the overall document ranking value. After calculating a reference value for a document based on the feature values for the document, a distribution can be sampled to generate the document ranking value.

### Features and Feature Values

In a document ranking calculation, many options are available for defining document “features” that contribute to the determination of a document rank. Each defined document feature can have a corresponding value that contributes to the overall document ranking. Some document features can be related to the presence of a search query keyword or token within the visible portion of a document. For example, a feature value could be based on the number of times a keyword appears on a page or based on a ratio of how many times one keyword in the search query appears relative to a second keyword within the search query. Other features can be based on location of keywords within a document. Examples of features can include the presence of a keyword in the title of a document, the presence of a keyword within the first fifty words of a document, the closest proximity of two keywords within a document, or the presence of keywords in the metadata for a document. Still other features can indirectly related or unrelated to a keyword from a search query. Examples of such features include the relative geographic location determined for a document relative to a location for the user submitting the search query, the number of links in the document, the number of prior page views for the document, the number of slashes appearing after the domain in the URL for the document, or even possibly a relationship between a category (like sports or news) for the document and a category associated with one or more of the keywords.

In this discussion, some features will be referred to as having “keyword-dependent” values and “keyword-independent” values. A keyword-dependent feature value is defined as a value for a feature that requires knowledge of the keywords in a query for evaluation. For example, consider a document that has a document title of “All Cars Eat Gas.” In a sample search engine, one feature can be the presence of a query keyword in the document title. In order to assign a value to this feature, the keywords in the query need to be determined. Thus, this feature is a keyword-dependent feature. By contrast, another feature considered by the search engine can be the number of links present in the document. The number of links present in the document can be evaluated without knowledge of the keywords present in the query. Thus, this is a feature that has a keyword-independent value.

In this discussion, some features will be referred to as having “query-dependent” values and “query-independent” values. A query-dependent feature value is defined as a value for a feature that is associated with a specific query. Again, consider a document that has a document title of “All Cars Eat Gas,” and a sample search engine with a feature corresponding to the presence of a query keyword in the document title. Two potential search queries that may match this document are “cars gas mileage” and “cars gas efficiency.” In a search engine that uses query-dependent values, feedback for features such as keyword in the document title can be stored on a per query basis. Thus, for the two potential queries mentioned above, feedback for query-dependent feature values can be stored separately, even though two of the three search terms are in common. By contrast, another feature considered by the search engine can be the number of links present in a document. The number of links present in the document can be evaluated without knowledge of the query. Thus, this is a query-independent feature.

Note that some embodiments will not involve the use either query-dependent feature values and/or keyword-dependent feature values. Additionally, the definition of a feature as query-dependent or keyword-dependent may vary depending on the nature of a search engine. For example, some search engines have features that compare the geographic location associated with a query with a geographic location associated with a document. In embodiments involving keyword-dependent features, this feature will typically be considered as a keyword-independent feature. However, in embodiments involving query-dependent features, this type of feature could be considered as query-dependent or query-independent. In such embodiments, some knowledge of the query is required, as the geographic location of the query is needed to evaluate this feature. However, a typical query-dependent keyword definition will be based on the keywords in the query. Since the geographic location of a query is typically unrelated to the keywords in the query, it will often be more practical to treat relative geographic location as a query-independent feature.

### Modeling Feature Values as Distributions

An initial step in generating variations in document rank based on feature variation is to allow one or more document features to have a value based on a distribution. This is in contrast to a document feature that has a single value. Alternatively, the document ranking itself can be the “feature” that has a value based on a distribution. Any convenient type of distribution can be used. The distribution can be symmetric or asymmetric with respect to a most probable value of the distribution. The distribution can be symmetric or asymmetric with respect to a mean or average value of the distribution.

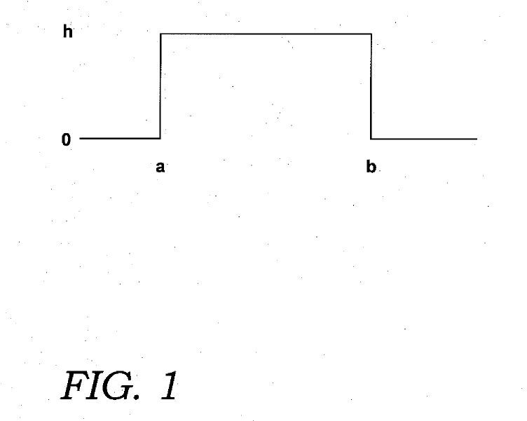

FIG. 1 shows an example of a simple type of distribution. The distribution in FIG. 1 can be thought of as the combination of two step functions. A first step function causes a rise in probability at position “a” to a height “h”, while the second step function returns the probability to 0 at position “b”. To sample this distribution, points would be selected so that the likelihood of selecting any point in the area under the curve has the same probability. As a result, the likelihood of selecting any value between “a” and “b” is the same, while values outside of the range “a” to “b” have a probability of zero. The type of distribution shown in FIG. 1 is a possible distribution that could be used according to the invention. However, it is likely that one of skill in the art would find the distribution shown in FIG. 1 to be less efficient than some other types of distributions.

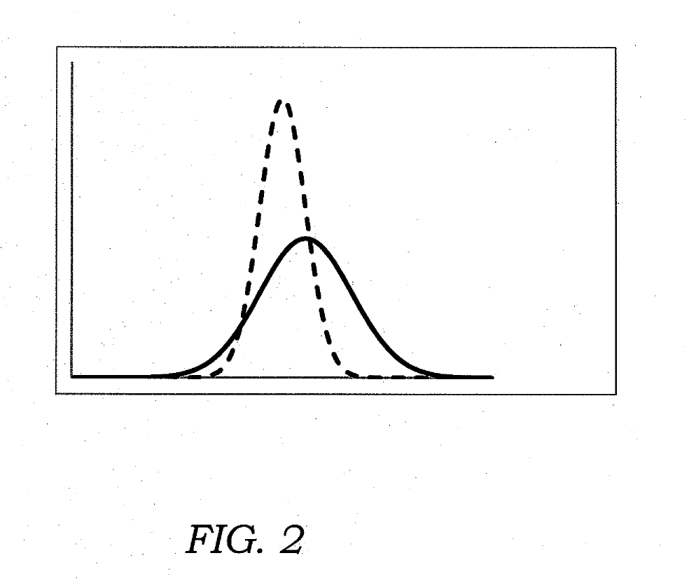

FIG. 2 shows two examples of Gaussian distributions. The area under a curve in a Gaussian distribution has a different shape than the dual-step-function distribution shown in FIG. 1. One feature that can be used to characterize a Gaussian distribution is the mean or central value for the distribution. In the distributions shown in FIG. 2, the mean value specifies the center of the distribution. When the distributions shown in FIG. 2 are sampled based on the area under the curve, the mean value is the most probable value that will result from the sampling. In this document, a mean value in a distribution will be referred to by the symbol μ. In the distributions shown in FIG. 2, the Gaussian distribution represented by the solid line has a larger mean value than the distribution represented by the dashed line.

Another value that can be used to characterize a distribution is a characteristic width for the distribution. For a Gaussian distribution, a commonly used characteristic length is the value a. For a Gaussian distribution, about 68% of the values in the distribution are within la of the mean, and about 95% of the values are within 26 of the mean. For other distributions, other types of characteristic lengths can also be used. For example, a common way of characterizing many distributions is to refer to the “full width at half maximum” value for the distribution. In the case of a Gaussian distribution, the full width at half maximum value corresponds to a length of (2×\sqrt{2 ln 2})σ. In the distributions shown in FIG. 2, the distribution shown by the dashed line has a greater width than the distribution shown by the solid line.

For clarity in explaining the nature of the invention, the discussion below will describe the invention using Gaussian type distributions. The discussion below will include references to the mean μ and the characteristic length σ of such distributions. However, this is a choice for convenience only, and those of skill in the art will recognize that distributions that do not have a characteristic length may be used. Similarly, functions that are asymmetric with respect to the mean value and/or functions where the mean value is not the most probable value may also be used. For example, FIG. 1 is an example of a distribution where the mean value is not the most probable value, as all values between “a” and “b” in the distribution of FIG. 1 are equally likely to be sampled. It is also noted that a Gaussian type distribution can correspond to a mathematical sampling method that approximates a Gaussian distribution. Those of skill in the art will understand that methods are available for generating random values that approximate sampling from a Gaussian distribution, as opposed to generating random numbers that are true samples from a Gaussian distribution. Such approximate sampling from a Gaussian distribution can also be used in various embodiments of the invention.

One method for assigning a value distribution to a feature can be to start with a reference value for the feature. The reference value for a feature will typically be a single value. The reference value can be generated using any convenient method used for generating feature ranking values in a search engine. One option can be to use the reference value as the mean value μ for the distribution, but in alternative embodiments a reference value for a feature can be related to the distribution in any other convenient manner.

In addition to selecting a reference value, a width for a distribution must also be determined. The determination of a width may be dependent on the type of distribution that will be used for the feature value distribution. For a distribution that has a characteristic value (such as σ for a Gaussian type distribution), the width for the distribution can be set in relation to the characteristic value for the distribution. Typically, the width value can represent an amount of uncertainty for the feature value. An initial width value may be based on a pre-defined uncertainty associated with a feature before any user feedback has been obtained. For example, an appearance of a keyword in a title may be considered a reliable indicator of a responsive document as compared to the appearance of a keyword in metadata for a document. Thus, the amount of width or uncertainty for a feature corresponding to a keyword in the title may be lower than the amount of uncertainty for a feature corresponding to the keyword appearing in the metadata. The width value can then be adjusted as additional user feedback becomes available.

After selecting a reference value and a width, a desired distribution of values can be generated for the feature. In some embodiments, this will correspond to selecting a reference value corresponding to the mean value μ and then generating a desired distribution around the mean value based on a selected width. Alternatively, any other convenient method can also be used for generating a distribution based on a reference value and a desired level of uncertainty or width. This distribution can then be sampled to generate sampled values from the distribution. The sampled value can then be added to the reference value to generate the final feature value or document ranking value. Optionally, other functional forms can be used for combining the reference value and the sampled value. For example, the sampled value can be multiplied by a scaling factor, and then the product of the sampled value and scaling factor can be added to the reference value.

One convenient method for generating values from a distribution can be to use a normalized distribution, such as a distribution generating values either between 0 and 1 or between −1 and 1. For each feature, the width of the distribution can be specified so that features with different levels of uncertainty can be represented. When using a normalized distribution, a scaling factor can also be specified for each feature, so that the product of a sampled value and the scaling factor corresponds to the desired amount of variation around the mean value. In an embodiment, sampling from a distribution such as a Gaussian distribution can be achieved by first selecting a random value from 0 to 1. The random value is then mapped to a standard number of deviations according to the cumulative density function for the distribution. In an example involving a Gaussian distribution, a random value of 0.5 maps to 0 deviations. A random value of 0.8 maps to 0.84 deviations. A random value of 0.2 maps to −0.84 deviations. A random value of 0.99 maps to 2.3 deviations. For a Gaussian distribution, and for a set of features where a feature match results in a positive feature value, an initial scaling factor for a normalized distribution can be the product of the mean μ and the width σ, or a fraction/multiple of such a value. In other embodiments, the scaling factor can be a multiple or fraction of the width σ.

In various embodiments, for a mean value μ and a width σ, the equation for determining a feature value (or a document ranking value) can be

feature value=μ+ε*k

where ε is the value sampled from the (normalized distribution) and k is either a constant, or possibly a multiple/fraction of μ*σ as described above. For distributions with a long tail (such as a Gaussian distribution), this format has the advantage of providing the basic shape of the corresponding distribution without having the risk of a sample from a long tail leading to a value that is undesirably far from the mean value μ. Another advantage is that a single distribution sampling algorithm can be used while specifying only one variable, the width to be used for the particular sample. Still another advantage is that this format for generating a feature value can facilitate updates to the reference value and/or the width or uncertainty of the distribution, as described below.

In some alternative embodiments, variations related to features can be applied in another manner. The above describes using a distribution to represent various feature values. Another option is to use single values for feature values, and instead to allow the coefficient of a feature value within a ranking algorithm to be sampled from a distribution. In a ranking algorithm, the various feature values are typically combined with each other using coefficients, so that different features can have different levels of importance within the ranking scheme. Those of skill in the art will recognize that using a distribution of values to represent a coefficient within a ranking algorithm can be implemented in the same manner as using a distribution of values for the feature value itself. The only change required is that instead of having feature values defined by

feature value=μ+ε*k

the feature value is set to μ, and the weight factor in the ranking algorithm for a coefficient is defined by

feature value coefficient=μ_{c}+ε_{c}*k_{c}

where μ_{c} is the mean value for the coefficient, ε_{c} is the sampled value for the coefficient, and k_{c} is the weighting factor for the coefficient.

In this discussion, the invention will be described with reference to using feature values that are sampled from a distribution. However, this choice is made for convenience in explaining various embodiments of the invention. Those of skill in the art will recognize that the description herein equally applies to embodiments where the coefficient within a ranking algorithm for a feature is sampled from a distribution, as opposed to the feature value being sampled from a distribution.

Generating a Document Ranking Based on Feature Values from a Distribution

After determining which features for a document will be represented by a distribution (or alternatively the coefficients for feature values in a ranking algorithm that will be represented by a distribution), a document ranking relative to a search query can be generated. The document ranking for a search query can be based on a mixture of features that have a single value and features having an associated distribution of values.

As an example, a hypothetical document ranking method could involve 250 features that contribute to a document ranking value. 150 of the features can be features that are represented by a traditional single value, while the other 100 features are represented by a distribution of values (or alternatively are features with coefficients in the ranking algorithm that are represented by a distribution of values).

In this example, a search query containing two keywords is received. A document ranking relative to the query can then be determined for a plurality of documents. The plurality of documents may correspond to all documents that a search engine is aware of. Alternatively, generation of a document ranking may be a multi-step process, where one or more initial sets of factors are used to filter a larger group of documents. For example, an initial filter could be to exclude any document that does not contain at least one of the keywords. After applying the one or more filters, a document ranking value is determined for remaining plurality of documents.

A document ranking value can be determined by combining the feature values for the 250 various features. Determining a feature value can begin by generating a reference value for each feature. The reference value for each feature can be generated by any convenient method, such as conventional methods for generating feature values within a search engine. In this example, for the 150 features that have a traditional single value, the reference value can correspond to the feature value. For the remaining 100 features, the reference value provides a basis for calculating the feature value based on a corresponding distribution. Based on the distribution type for each of the 100 features, and optionally a width or uncertainty value for each feature, the distribution is sampled to generate a feature value for use in this particular instance of receiving the search query. In this example, each of the 100 features has a Gaussian shaped distribution. A normalized Gaussian distribution having is sampled to generate a value between −1 and 1, and this sampled value is multiplied by a scaling factor associated with each feature. The product of the sampled value and scaling factor is added to the mean value to obtain the feature value for a particular feature. The 250 feature values are then combined according to the ranking method to generate the document ranking value for this instance of the search query. Each time a search query is received, whether the query contains the same keyword or different keywords, the query can be considered a new instance and the process of generating a document ranking value can be repeated.

It is noted that at least some of the above steps can be performed prior to receiving the particular instance of a search query. For example, search engines routinely employ an inverted index to identify the presence or absence of various features in a document, such as the presence of a keyword or the location of a keyword in a document. For feature values based on presence or absence of a single keyword, the reference value for any document containing the keyword can be determined in advance. As another example, for common pairs of keywords, it may be beneficial to compute in advance the reference values for a document. When the reference value for one or more features is known in advance, the known reference value can be used when determining the feature value. Instead of calculating the reference value again, receipt of a search query can trigger just the sampling from the distribution, followed by combining the reference value, sampled value, and scaling factor to determine the feature value.

In an expansion of the above example, of the 250 features, 200 can correspond to features that are dependent on the keywords in the search query and/or the context of the search query. The remaining 50 features are dependent only on the nature of the document itself, and do not change based on the nature of the search query or the query context. In this expanded example, reference values for the 50 features that are dependent on the nature of the document can be determined in advance.

In some embodiments, each submission of a search query to a search engine corresponds to a separate instance, resulting in generation of a new document ranking value. However, in order to maintain a consistent user experience, it may be desirable to maintain the document rankings relative to a given search query when a search query is submitted more than once in a short period of time with the same context. In this type of optional embodiment, document rankings would be kept constant for a user that submits an identical search query multiple times within a time period, such as queries submitted within a 5 minute period or queries submitted within a single search engine session.

Generating a Document Ranking Value from a Distribution

Alternatively, a distribution can be used to directly generate document ranking values. In this alternative embodiment, feature values for a document based on a search query can be determined in a conventional manner, or at least some feature values can be determined based on sampling a distribution as described above. After all feature values have been generated, a reference value for a document is calculated. A distribution associated with the document is then sampled, and the sampled value can optionally be multiplied by a scaling factor. The sampled value (optionally multiplied by the scaling factor) can then be added to the reference value to calculate the document ranking value.

Incorporating Feedback into Ranking Values

In response to each search query, a listing of responsive results can be provided. Typically, a consistent format will be used for presentation of results. For example, a user interface for displaying search results can include a listing of ten results. Each result can be initially displayed with a link in the form of a document title, a snippet from the document, and an indication of the uniform resource locator (URL) for the document. In this example, a paid listing can be included between the second and third results. The paid listing can be identified by having a different background color than the surrounding non-paid results. The text size in the user interface can be scaled so that an average screen display will show the top five results without a user having to scroll the page.

Based on the above page format, user browsing history information can be generated to determine general trends for how users interact with results. For example, for search queries including two keywords, user browsing history information may show that on average 90% of users interact with the first result, while 70% interact with the second result. Due to an unexpected halo effect from the paid advertisement, the interaction rate with the third result is 48%, while the fourth and fifth results have an interaction rate of 50%. Because results 6-10 require user scrolling of the page in a typical browser environment, the interaction rates for results 6-10 are below 20%.

In the above hypothetical example of interaction rates based on page layout, it can be seen that each display location on a page can potentially lead to a different expected rate of interaction by a user. Because of the high rate of interaction of users with the top result, it may be relatively easy to determine that users dislike a result shown in the first result position, but more data may be needed to determine that users have a higher than normal favorable rating for a result in the first display position. Similarly, positive feedback in positions 6-10 may be more instructive than negative feedback, due to the lower expectation that a user would interact with a result in those positions. In this hypothetical example, feedback can be generated based on whether a user has any interaction with a result. Alternatively, feedback could be based on specific types of interactions, with a different interaction rate for each type of interaction such as hovering a pointer over a link, clicking on a link, and spending a minimum amount of time viewing a document corresponding to a clicked link. Preferably, the mechanism for incorporating user feedback information into the document ranking algorithm can account for this type of positional information.

One method of incorporating feedback into the ranking algorithm can be to base feedback on a comparison of user interactions with document display position. In the hypothetical example, interaction by a user with a link can be a binary function, so that interaction either occurs (100%) or it does not occur (0%). This can reflect whether a user clicks on a displayed link or not, or whether a user hovers over a link or not. Alternatively, some types of user feedback can have a wider range of values. For example, some user interfaces for displaying results will provide additional information about a result if the user allows the mouse pointer to hover over the result. A series of feedback variables could be developed based on how many seconds a user hovers over the result. The feedback variables could include, for example, a variable for hovering up to one second, a variable for hovering up to 10 seconds, and a variable for hovering for a minimum of 2 seconds and up to 6 seconds. In this type of example, the second result on the page might have an expected average hover time of 4 seconds. Relative to the three variables, this would correspond to an expected value of 100% for the up to 1 second variable, an expected value of 40% for the up to 10 seconds variable, and an expected value of 50%[(6−2)/(4−2)] for the third variable. A hypothetical user then might interact with a second result for 1 second. This would lead to an actual value of 100% for the first variable (up to 1 second), an actual value of 10% for the second variable (1 second out of 10 seconds), and an actual value of 0% for the third variable (1 second is below the threshold level for the variable).

The user interaction percentage with a result can then be compared with the expected interaction percentage based on the position in the results display in order to generate an update value. The amount of width or uncertainty currently in a distribution can also be used to determine an update value. For example, for the Gaussian functions used in this example, one potential functional form for an update value Uᵥ be

$${U}_{v} = \frac{{σ}^{2}}{c} * ( {p}_{interaction} - {p}_{expected} )$$

where σ is the characteristic value for the Gaussian associated with a feature, p_{interaction} is the percentage of interaction between a user and the result, p_{expected} is the expected likelihood of interaction, and c is a weighting factor. The weighting factor c allows for control over how quickly or slowly update information impacts the mean and/or width value. The weighting factor c can be common for all features, or each feature can have a separate c corresponding to the feature. Based on the update value, updates to the mean and the width can be calculated as

$${μ}_{new} = μ + {U}_{v} ;$$

$${σ}_{new} = σ * [ 1 - \frac{{U}_{v}}{c} ]$$

where u_{new} and σ_{new} represent the updated values for the mean and width, respectively. In alternative embodiments, additional factors can be incorporated into the update function. For example, the update value Uᵥ shown above is directly proportional to the difference between the actual and expected interaction values. This corresponds to incorporating the actual and expected interaction values in a linear form. Another option can be to have Uᵥ depend on the actual and expected interaction values in another manner, such as a “1/x” type dependence or a logarithmic dependence. Additional and/or different weighting factors can also be incorporated, to change the relative amount of update experienced by the mean and width values. Also, different functional forms and/or constant values can be used for the update value of different features. Another example of a feedback algorithm that can account for location or position information is an algorithm like the TrueSkill™ Ranking System developed by Microsoft Corporation.

The method of updating values can be applied to all feature values for a document, or the above method can be used to update a document ranking value. When used for updating document feature values, in some embodiments a distinction can be made between updates for keyword-dependent feature values and keyword-independent feature values. When keyword-dependent feature values are used, each combination of a keyword and a keyword-dependent feature corresponds to a separate distribution that can be sampled and updated. For example, one feature can be the presence of a keyword in the title of a document. If the presence of a keyword in the document title is a keyword-dependent feature, then a separate mean and width value can be maintained for each different keyword in the title. For a document titled “Every Good Boy Does Fine”, there would be five separate keyword-feature combinations for which to maintain a mean value and width value, or alternatively for which to maintain updates to the initial mean value and width value. By contrast, for keyword-independent feature values, only one mean value and width value would be needed for a given feature. Note that according to the definition of a keyword, a keyword-dependent value can be based on a partial keyword and/or multiple keywords from a query.

In other embodiments, features and/or the document ranking can correspond to query-dependent values. For a query-dependent value, each combination of a query and a query-dependent feature (or document rank) corresponds to a separate distribution that can be sampled and updated. In such embodiments, query-independent feature values have only one mean value and width value.

With regard to storing the μ_{new} and σ_{new} values, this can be done in any convenient manner. For example, for features that are dependent on the nature of the keywords in a search query, the μ_{new} and σ_{new} can be represented as difference values that are applied to the reference value generated by the search engine for a document. A document index can be used to store these values for each document. Alternatively, the μ_{new} and σ_{new} values for each feature can be stored along with the description of each document in the search engine. Optionally, for keyword-dependent feature values, the μ_{new} and σ_{new} values for features associated with the keyword can be stored with the document identifier in the inverted index entry for that document. For example, if a document is provided as a result in response to the keyword “pizza”, a μ_{new} and σ_{new} value for each keyword-dependent feature can be associated with the keyword pizza. When a search query is received that includes the word “pizza”, each feature that has a feature value based on the word “pizza” can then be modified based on the associated μ_{new} and σ_{new} values.

Based on the above update method, each time a set of search results are provided to a user, such as a user that has granted permission for tracking of user behavior, the interaction between the user and the search results can be determined. The actual interaction can be compared with the expected interaction. The mean values and width values for each feature can then be updated by determining an update value as described above.

### Example of Feature Valuation and Document Ranking

In this prophetic example, the calculation of feature values for a limited number of features will be detailed as part of determining a document rank for a document. The document that will be ranked in this example is a new web site for a pizza restaurant named The Hypothetical Pizza Place. This pizza restaurant is located in College City near a college campus. The web site for The Hypothetical Pizza Place indicates that the pizza shop will generally deliver to a residential address, but that no delivery is available on the college campus.

In this example, a first search query is submitted by a student from a location on the college campus. As a result, the query location is detected as being at the college campus. The keywords in the query are “College City pizza”. Based on this search query, the search engine identifies the words “College City” as likely being intended as a single keyword. Therefore, the query is reformulated by the search engine as “College City” and “Pizza”. The highest ranking results from the combination of “College City” and “pizza” are then identified by the search engine.

Based on the query “College City pizza”, the new web page for the pizza restaurant is retained after the initial filters. A document rank is then developed for the new web page. The keyword “College City” is recognized by the search engine as potentially being a geographic indicator. Therefore, documents having a location of College City are also matched, even if the term “College City” is not present explicitly in the document. The keyword “pizza” matches the title of the web page, and it matches the name of the new pizza restaurant as displayed on the web page. The keyword pizza is also matched within the body of the text on the page as well as matching a metadata keyword for the web page. Each of these features has a reference value of 1.0 within the search engine ranking system. An approximately Gaussian distribution shape is selected for each of the feature distributions. In this example, the Gaussian or approximately Gaussian distributions are not normalized. The characteristic length (σ) of the distribution for the web page title feature and the restaurant (or entity) name feature is initially 0.1. The initial width for the metadata match is 0.15. Metadata is a somewhat less reliable indicator of a responsive document, so the uncertainty for this feature is greater. Similarly, the general web page match is a less reliable indicator, so that initial width is also 0.15. Additionally, the location for the web page is identified as being within 1 mile of the location associated with the search query. This feature has a reference value of 2.2 within the search engine ranking system. The initial width for this distribution is based on a value of σ of 0.3, while the height (and mean value μ) of the distribution corresponds to the reference value of 2.2. Other features are also considered, but in this example the calculations are described only for the above features.

After receiving the “College City pizza” query, the distribution for each of the above features is sampled. Due to the feature value for being within 1 mile of the search, based on the reference values for the features, the document would have ranked first. However, the c values randomly sampled from the distribution for the features were −0.18, −0.02, 0.03, −0.04, and −0.06, respectively. The feature values for each feature were calculated using μ+ε*k, where ε is the sampled value for a feature and the scaling factor k is equal to 4σ (four times the distribution width) for the feature. Due to the random selection of several negative values for the sampled value c, the sum of the feature values described here dropped from 5.200 to 5.114. This reduction in feature values is sufficient to change the document from being the highest ranked document to the third highest ranked document.

The document is then presented to the user in the third display position on the results page. In this example, the third position has an expected click rate of 60%. Because the pizza restaurant is popular with the students on the campus, the user clicks on the result corresponding to the pizza restaurant. Thus, the actual click rate for the result is 100%.

Based on the interaction of the user with the results, the values for each feature are updated. The values are updated using the update value feature described above. Because the result was clicked, the actual result had a greater value than the predicted result. This leads to an increase in the mean value for each feature, as well as a decrease in the width value for each feature. For example, using the equations above, the update value can be computed for each feature. The same constant “c” can be used for each feature. The value of c can be set to 2. For the features having a width of σ=0.15, and based on the actual click rate of 100% (or 1.0) versus the expected click rate of 60% (or 0.6), the update value would be [(0.15)²/2]*(1.0−0.6)=0.0045. This update value can be added to the mean value as shown above to generate the new mean value. The update value can also be used as shown above to change the width of the distribution. Typically, the distribution will narrow after receiving additional feedback. It is noted that the change in the mean value (or width) based on any given user interaction is small. By selecting a larger value for c, or by making other changes to the formula, a smaller or larger rate of change can be achieved. Similar calculations can be performed for the features having a width of 0.1 or 0.3 to find the update values for those features.

After updating the values, another query is received from a second user on the college campus. The query contains the keywords “pizza delivery”. Reference values are computed for each feature based on the keywords. For the feature values corresponding to distributions, the reference values can be modified to reflect the user feedback. In this example, the keyword “pizza” was used in the previous search query, but the keyword “delivery” was not. As a result, feature values based on the keyword “pizza” have been modified to have the updated feature value based on the feedback. For example, the keywords “pizza” and “delivery” both appear in the metadata for this document. The feature of having a keyword appear in the metadata has a base reference value of 1 in the document ranking algorithm. This feature had an initial width of 0.15. The prior search also involved pizza, and resulted in an increase of 0.0045 for features having an initial width of 0.15. Thus, the feature of having the word “pizza” appear in the metadata received an increase in reference value to 1.0045. By contrast, for the keyword “delivery”, since this is the first search involving the word “delivery”, the default value reference value of 1.0 still applies for having the keyword “delivery” appear in the metadata.

Based on the full document ranking calculation, the web site for The Hypothetical Pizza Shop would be placed in the fifth result location based on the reference values. In this example, after sampling the distributions and converting reference values into feature values, the document still ends up in the fifth result location. Because The Hypothetical Pizza Shop does not deliver to the college campus, the user does not interact or click on the result for The Hypothetical Pizza Shop. This leads to an actual result of 0% for this search, compared to an expected interaction of 45% for a result in the fifth result location. Based on this feedback, update values are generated again for features having a distribution. This time, the update value results in a lower mean value.

Over time, as many searches are processed, the update value procedure will allow the search engine to modify the feature values based on distributions for the document corresponding to The Hypothetical Pizza Shop web page. Over time, the feature values involving the keyword “pizza” and/or feature values based on geographical location being within 1 mile will be updated to reflect the preference of the college students for The Hypothetical Pizza Shop when they want to visit The Hypothetical Pizza Shop or place a carry-out order. By contrast, features based on the keyword “delivery” will be updated to have lower reference values, due to the lack of delivery to the college campus. Because the result display location of the web page can vary in response to the same search query, this feedback can be obtained and incorporated more quickly. Additionally, as more data is collected, the width values for the various features will decrease, leading to less variation in the relative ranking of the document.

### Example of System for Performing Invention

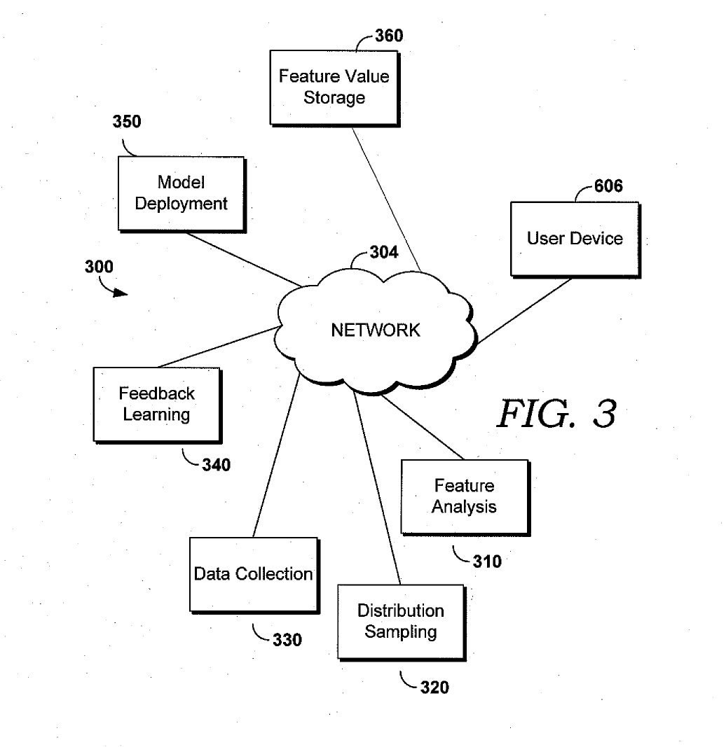

FIG. 3 shows an example of a system suitable for performing various embodiments of the invention. In the embodiment shown in FIG. 3, the system is shown as operating in a network environment 300. In various embodiments, one or more components shown in FIG. 3 can be incorporated into a single processor or computing device. Alternatively, the general network 304 shown in FIG. 3 can represent multiple networks, such as a local area network for connecting one or more components and a wide area network for connecting the remaining components and optionally a user device 306. The environment 300 is but one example of an environment that can be used in embodiments of the invention and may include any number of components in a wide variety of configurations. The description of the environment 300 provided herein is for illustrative purposes and is not intended to limit configurations of environments in which embodiments of the invention can be implemented.

The network 304 includes any computer network such as, for example and not limitation, the Internet, an intranet, private and public local networks, and wireless data or telephone networks. The user device 306 can be any computing device from which a search query can be provided. For example, the user device 306 might be a personal computer, a laptop, a server computer, a wireless phone or device, a personal digital assistant (PDA), or a digital camera, among others. In an embodiment, a plurality of user devices 306, such as thousands or millions of user devices 306, can be connected to the network 304.

In the embodiment shown in FIG. 3, the system can include a feature analysis component 310 for determining features and reference values for a document. The feature analysis component 310 can work in conjunction with a distribution sampling component 320 to determine feature values (or feature value coefficients) for features that are modeled as a distribution of values. A data collection component 330 can collect the data that will be used as feedback. A feedback learning component 340 can process the data collected by data collection component 330 to provide update values for feature analysis component 310 and distribution sampling component 320. A model deployment component 350 can allow the updated values to be incorporated into the feature analysis component 310 and the distribution sampling component 320. Optionally, a separate feature value storage component 360 can be used to store updated data regarding distributions for feature values. This updated data can then be accessed by other components as needed.

In the embodiment shown in FIG. 3, feature analysis component 310 corresponds to a component that breaks down a document into potential features and then provides reference values for the features relative to a search query. The reference values can be reference values for feature values, feature value coefficients, or a combination of feature values and feature value coefficients. A variety of existing search engines are available that perform this task. However, conventional search technology only includes providing reference values, which are single values. Feature analysis component 310 is configured to allow one or more feature values (or one or more feature value coefficients) to be represented as a distribution of values.

Distribution sampling component 320 can be incorporated into feature analysis component 310, or distribution sampling component can represent a separate component. Distribution sampling component 320 can receive information regarding a distribution. This can optionally include receiving a reference value for the distribution (such as the mean), a distribution shape or type (such as a Gaussian distribution or a distribution that approximates a Gaussian distribution), and a width or other information that defines the distribution for sampling. The distribution sampling component 320 can then provide sampled values from the distribution for use in calculating feature values (or feature value coefficients). In some embodiments, the distribution sampling component 320 can be configured to sample from only one type of distribution, so that only the distribution width information is needed to perform sampling. Optionally, the distribution sampling component 320 can sample from a normalized distribution having the appropriate width. In this type of option, the distribution sampling component 320 does not need to know the mean value information for the distribution. Instead, the distribution sampling component can provide the normalized sample value to feature analysis component 310 for calculation of a feature value.

Data collection component 330 can correspond to any type of component for acquiring user feedback information. For example, a user can agree to use a search engine toolbar that allows for tracking of user interaction with results presented by the search engine. Alternatively, data collection component 330 can be a component for receiving information generated by a third party toolbar. Any convenient type of user interaction information can be collected, such as click through rates, mouse pointer hover rates, or page view times after click through. This data can optionally be stored, such as in feature distribution storage component 360.

Based on the collected data, feedback learning component 340 can update the distribution mean (or other reference value) and width information for the various feature distributions. This can be performed as data is received. Alternatively, feedback data can be aggregated to allow the learning component to process the data based on average values. For example, data can be broken down by search query, and then by the result display position. This aggregated data can then be used to determine average interaction values. The update to the feature values can then be determined using the average interaction values on a periodic basis, such as once an hour. This type of processing can save time, but features that are dependent on factors other than the search query may not be represented as well. For example, averaging over multiple queries can make it difficult to identify whether a geographic feature is more or less important for a document.

Model deployment component 350 allows the updated feature distribution information to be incorporated into the feature analysis component 310 and/or distribution sampling component 320. In the discussion above, search queries were processed as they were received and then used to provide feedback for the model. In practice, it may be desirable to filter some search queries before allowing the search queries to be used as feedback. For example, toolbars or other data collection components 330 may only provide information regarding user activity on a periodic basis. After collecting the user information, the information can be filtered to remove undesirable search queries, such as queries that appear to be submitted by automated bots as opposed to human users. Since the feedback information may be received in a batch form (as opposed to continuously), it may be more convenient to process the feedback information in batches and then provide periodic updates for the model.

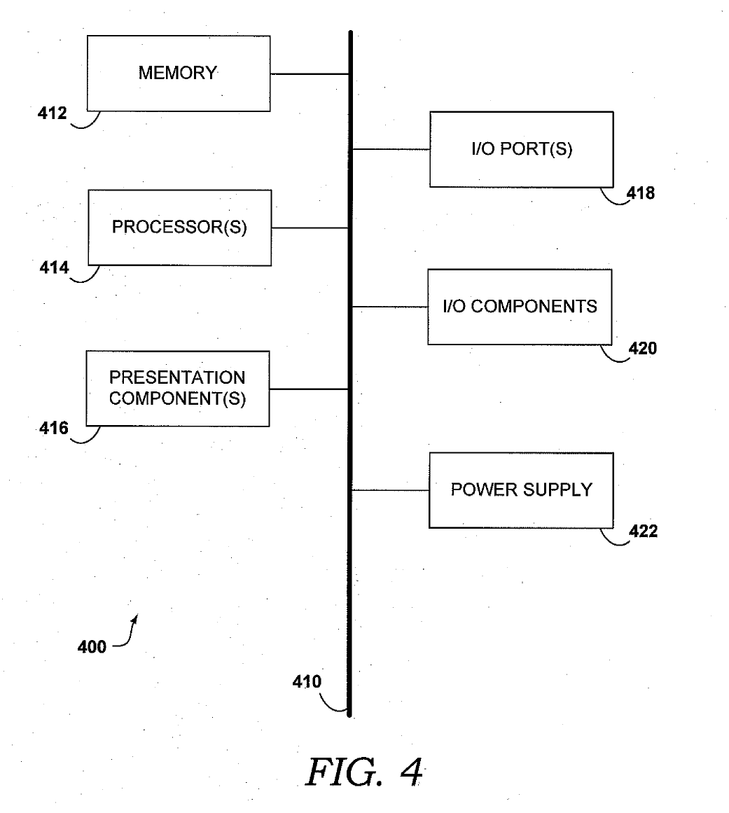

Having briefly described an overview of various embodiments of the invention, an exemplary operating environment suitable for performing the invention is now described. Referring to the drawings in general, and initially to FIG. 4 in particular, an exemplary operating environment for implementing embodiments of the present invention is shown and designated generally as computing device 400. Computing device 400 is but one example of a suitable computing environment and is not intended to suggest any limitation as to the scope of use or functionality of the invention. Neither should the computing device 400 be interpreted as having any dependency or requirement relating to any one or combination of components illustrated.

Embodiments of the invention may be described in the general context of computer code, software, or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

With continued reference to FIG. 4, computing device 400 includes a bus 410 that directly or indirectly couples the following devices: memory 412, one or more processors 414, one or more presentation components 416, input/output (I/O) ports 418, I/O components 420, and an illustrative power supply 422. Bus 410 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 4 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 400. In an embodiment, the computer storage media can be selected from tangible computer storage media. In another embodiment, the computer storage media can be selected from non-transitory computer storage media.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The memory 412 can include computer-storage media in the form of volatile and/or nonvolatile memory. The memory may be removable, non-removable, or a combination thereof. Exemplary hardware devices include solid-state memory, hard drives, optical-disc drives, etc. The computing device 400 includes one or more processors that read data from various entities such as the memory 412 or the I/O components 420. The presentation component(s) 416 present data indications to a user or other device. Exemplary presentation components include a display device, speaker, printing component, vibrating component, and the like.

The I/O ports 418 can allow the computing device 400 to be logically coupled to other devices including the I/O components 420, some of which may be built in. Illustrative components can include a microphone, joystick, game pad, satellite dish, scanner, printer, wireless device, etc.

### Additional Embodiments

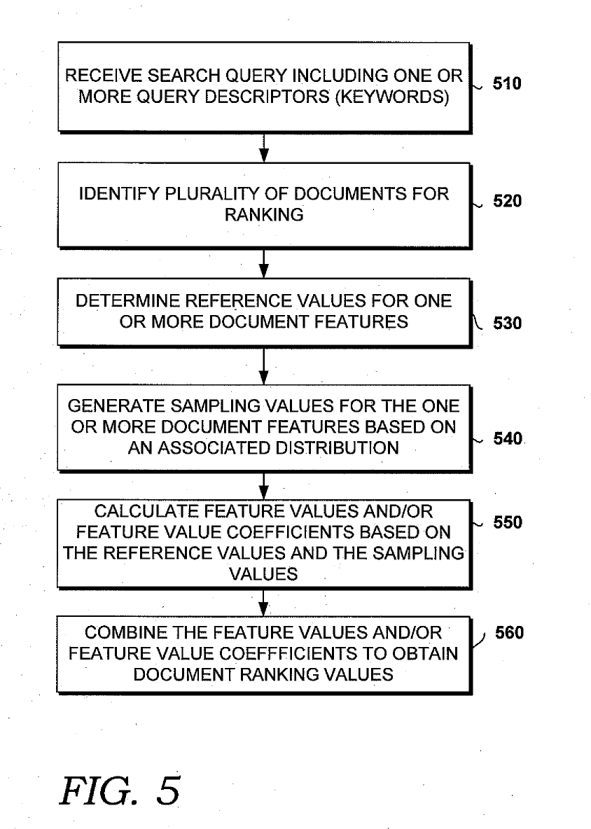

In an embodiment shown in FIG. 5, a method for ranking documents is provided. The method includes receiving 510 a search query that includes one or more query descriptors. The query descriptors can be keywords, or any other type of token included within a query that can be used for identifying a match. Preferably, when at least one of the query descriptors is a keyword, the number of keywords can be less than a threshold number, such as three or less. A plurality of documents can be identified 520 for ranking relative to the search query. The documents that will be ranked relative to the search query can represent a subset of all available documents, such as a filtered list of documents created based on matching of one or more features of the documents with the search query. Reference values can be determined 530 for one or more document features. Sample values can then be generated 540 for the one or more document features based on a distribution associated with the document features. Any convenient distribution can be used. Examples of distributions can include Gaussian distributions or distributions that approximate a Gaussian distribution. Feature values and/or feature value coefficients can then be calculated 550 based on the reference values and the sampling values. Optionally, the calculation of the feature values and/or feature value coefficients can also include a scaling factor for the sampling values. The feature values and/or feature value coefficients can be combined 560 to obtain document ranking values.

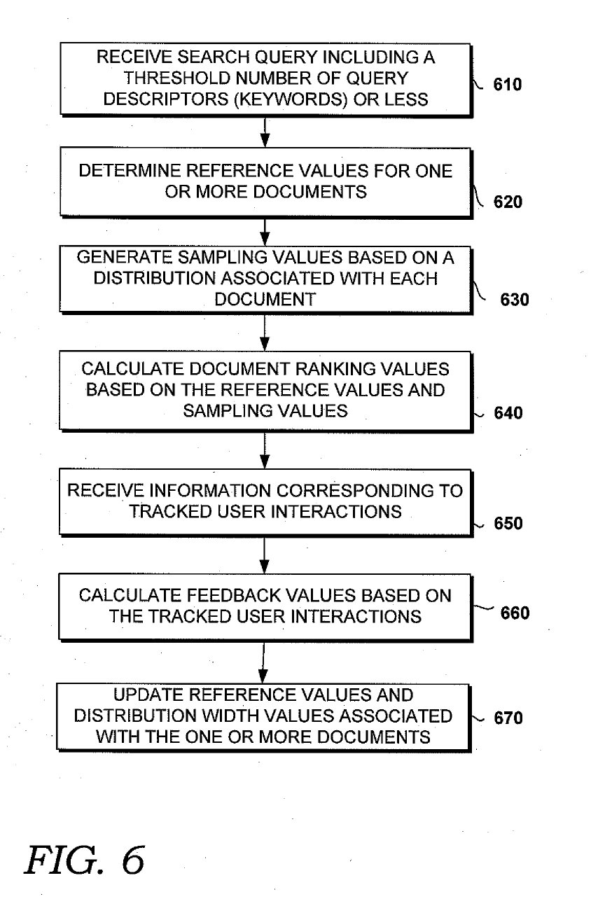

In an embodiment shown in FIG. 6, a method for ranking documents is provided. The method includes receiving 610 a search query including a threshold number of query descriptors (such as keywords) or less. Reference values can be determined 620 for one or more documents. Sampling values can also be generated 630 based on a distribution associated with each document. Document ranking values can then be calculated 640 based on the reference values and the sampling values. After providing the ranked documents as results for display, user interactions with the displayed results can be tracked. Information corresponding to the tracked user interactions can be received 650. Feedback values can be calculated 660 based on the tracked user interactions. Reference values and distribution width values associated with the one or more documents can then be updated 670.

In another embodiment, a method for ranking documents is provided. The method includes receiving a search query, the search query including one or more query descriptors; identifying a plurality of documents for ranking based on the search query; determining reference values associated with one or more document features based on the search query, the reference values corresponding to one or more feature values, one or more feature value coefficients, or a combination of feature values and feature value coefficients; generating sampling values associated with the one or more document features, the sampling values being based on a distribution associated with each document feature, the distribution associated with each document feature having a distribution width value; calculating at least one of a feature value or a feature value coefficient for the one or more document features based on the determined reference values and the generated sample values; and combining the calculated feature values, feature value coefficients, or combination of feature values and feature value coefficients to obtain document ranking values for the plurality of documents.

In still another embodiment, a method is provided for ranking documents. The method includes receiving a search query, the search query including a threshold number of query descriptors or less; determining reference values for one or more documents based on the search query; generating sampling values for the one or more documents, the sampling values being based on a distribution associated with each document, the distribution associated with each document having a distribution width value; and calculating document ranking values for the one or more documents based on the reference values and the sampling values for the one or more documents.

In yet another embodiment, a system is provided for generating document rankings. The system includes a feature analysis component configured to determine feature values for a document based on a search query; a distribution sampling component configured to generate sampled values for feature values, feature value coefficients, or a combination of feature values and feature value coefficients that are represented by a distribution of values; a data collection component for receiving data corresponding to user interactions; and a feedback learning component configured to determine update values for feature values, feature value coefficients, or a combination of feature values and feature value coefficients based on received user interaction data.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. One or more computer-storage media storing computer-useable instructions that, when executed by a computing device, perform a method for ranking documents, comprising:
receiving a search query, the search query including one or more query descriptors;
identifying a plurality of documents for ranking based on the search query;
determining reference values associated with one or more document features based on the search query, the reference values corresponding to one or more feature values, one or more feature value coefficients, or a combination of feature values and feature value coefficients;
generating sampling values associated with the one or more document features, the sampling values being based on a distribution associated with each document feature, the distribution associated with each document feature having a distribution width value;
calculating at least one of a feature value or a feature value coefficient for the one or more document features based on the determined reference values and the generated sample values; and
combining the calculated feature values, feature value coefficients, or combination of feature values and feature value coefficients to obtain document ranking values for the plurality of documents.

2. The computer-storage media of claim 1, further comprising:
receiving information corresponding to tracked user interactions with displayed results;
calculating feedback values for the one or more document features for at least one document; and
updating the reference values and distribution width values associated with one or more of the document features based on the calculated feedback values.

3. The computer-storage media of claim 2, wherein calculating feedback values for the one or more document features comprises:
calculating measured user interaction values from the received tracked user interactions;
determining difference values between expected user interaction values and the measured user interaction values for the plurality of documents;
identifying at least one document from the plurality of documents having a difference value greater than a feedback threshold value;
calculating feedback values for document features of the identified at least one document; and
updating the reference values and distribution width values associated with the document features of the identified at least one document.

4. The computer-storage media of claim 1, wherein at least one query descriptor in the search query is a keyword, the search query including a threshold number of keywords or less.

5. The computer-storage media of claim 1, wherein combining feature values to obtain document ranking values for the plurality of documents further comprises:
determining feature values for one or more additional features represented by single values; and
combining the calculated feature values and the determined feature values to calculate the document ranking values.

6. The computer-storage media of claim 1, wherein the one or more document features include at least one keyword-dependent document feature and at least one keyword-independent document feature.

7. The computer-storage media of claim 1, wherein the one or more document features include at least one query-dependent document feature and at least one query-independent document feature.

8. The computer-storage media of claim 1, wherein the calculated feature values are further based on scaling factors for the one or more document features.

9. The computer-storage media of claim 1, wherein determining reference values for the one or more document features comprises:
calculating initial reference values using a ranking algorithm; and
modifying initial reference values based on feedback values.

10. The computer-storage media of claim 1, wherein generating the sampling values comprises generating sample values based on a Gaussian distribution or based on a distribution that approximates a Gaussian distribution.

11. One or more computer-storage media storing computer-useable instructions that, when executed by a computing device, perform a method for ranking documents, comprising:
receiving a search query, the search query including a threshold number of query descriptors or less;
determining reference values for one or more documents based on the search query;
generating sampling values for the one or more documents, the sampling values being based on a distribution associated with each document, the distribution associated with each document having a distribution width value; and
calculating document ranking values for the one or more documents based on the reference values and the sampling values for the one or more documents.

12. The computer-storage media of claim 11, wherein the query descriptors are keywords, and wherein the search query includes three keywords or less.

13. The computer-storage media of claim 11, wherein the distribution width value is based on a characteristic width for the associated distribution.

14. The computer-storage media of claim 11, further comprising:
receiving information corresponding to tracked user interactions with displayed results;
calculating feedback values for the one or more documents based on the tracked user interactions; and
updating the reference values and the associated distribution width values for the one or more documents based on the calculated feedback values.

15. The computer-storage media of claim 14, wherein calculating feedback values for the one or more documents comprises:
calculating measured user interaction values from the received tracked user interactions;
determining difference values between expected user interaction values and the measured user interaction values for the one or more documents;
identifying at least one document from the one or more documents having a difference value greater than a threshold value;
calculating feedback values for the at least one document having a difference value greater than a feedback threshold value; and
updating the reference values and the associated distribution width values for the at least one document having a difference value greater than the feedback threshold value based on the calculated feedback values.

16. The computer-storage media of claim 11, wherein calculating document ranking values comprises:
combining the reference value, sampling value, and an optional scaling factor for each document to generate variable ranking portions, the variable ranking portions corresponding to feature values for each document represented by value distributions;
determining feature values for one or more additional features represented by single values; and
combining the variable ranking portions and the determined feature values to calculate the document ranking values.

17. A system for providing document rankings, comprising:
a feature analysis component configured to determine feature values for a document based on a search query;
a distribution sampling component configured to generate sampled values for feature values, feature value coefficients, or a combination of feature values and feature value coefficients that are represented by a distribution of values;
a data collection component for receiving data corresponding to user interactions; and
a feedback learning component configured to determine update values for feature values, feature value coefficients, or a combination of feature values and feature value coefficients based on received user interaction data.

18. The system of claim 17, further comprising a deployment component configured to provide the update values to the feature analysis component.

19. The system of claim 17, wherein the distribution sampling component generates sampled values from a Gaussian distribution or a distribution that approximates a Gaussian distribution.

20. The system of claim 17, wherein the feedback learning component is configured to determine update values corresponding to updates for reference values and distribution width values.
